(19) United States
(12) Patent Application Publication
(10) Pub. No.: US 2006/0152954 A1
(43) Pub. Date: Jul. 13, 2006

(54) Current control circuit for controlling inrush current through an energy storage capacitor of a power supply

(75) Inventors: Milan M. Jovanovic, Cary, NC (US); Yungtaek Jang, Cary, NC (US); Chi-Hsing Huang, Chungli Industrial Park (CN)

Correspondence Address: VENABLE LLP, P.O. BOX 34385, WASHINGTON, DC, 20045-9998, US

(73) Assignee: Delta Electronics, Inc., Taipei (TW)

(21) Appl. No.: 11/030,117

(22) Filed: Jan. 7, 2005

(51) Int. Cl. H02M 7/04; H02M 5/42

(52) U.S. Cl. 363/89

(57) ABSTRACT

The present invention relates to a current control circuit for controlling inrush current through an energy storage capacitor of a power supply having an input voltage. A semiconductor device is coupled in series to the energy storage capacitor; and a control circuit produces a constant current through the semiconductor device during an inrush current period when the energy storage capacitor is charged by the input voltage to reach an energy storage capacitor voltage that causes the semiconductor device to act as a short switch.

### BACKGROUND OF THE INVENTION

1. Field of the Invention

The present invention generally relates to current control circuits and more particularly to current control circuits that limit the magnitude of the inrush current that flows through the energy storage capacitor of a power supply.

2. Description of the Prior Art

As is well known, a large inrush current flow occurs during a short interval, after the initial application of input power to the energy storage capacitor of a power supply. The initial application of the input power for the first time creates what is known as a “cold startup” condition. Another operating condition for the power supply is known as “warm startup” condition, which is when the input power is reapplied after a temporary loss of power, for example, due to power line disturbance conditions. The majority of today's data processing equipment require power supplies to maintain output voltages within a specified range for a given time period after a drop-out of the input power. The required energy to support the output power during this time is obtained from a relatively large energy storage capacitor that is properly sized for a desired application. However, because of the relatively large energy storage capacitor, the inrush current after the input power source is applied for the first time and/or reapplied after a power source drop-out can be very large. Generally, if the magnitude of the peak inrush current under both cold-startup and warm-startup conditions is not limited below the rating of the power supply components, the excessive inrush current could lead to a failure.

In one prior art approach disclosed in U.S. Pat. No. 5,122,724 issued to Criss, a control circuit limits the inrush current in DC-DC and DC-AC power supplies using a FET (Field-Effect-Transistor) switch that is coupled in series with the energy storage capacitor. The FET switch is controlled by an RC circuit connected across the series combination of the energy storage capacitor and the FET switch so that that energy storage capacitor is connected between the gate and the source of the FET switch. After the application of the input power, a slowly increasing and non-constant voltage of the energy storage capacitor connected across the gate-to source terminals of the FET switch continuously changes the value of the channel resistance of the FET switch from high to low. As a result, the peak inrush current is limited by a relatively large initial value of the channel resistance of the FET switch, whereas the power loss of the FET switch is minimized by minimizing the channel resistance of the FET switch after the inrush-current period is over. While this circuit can be designed to limit the inrush current during cold startup, the circuit may not be able to provide a reliable current limiting function after the input power is re-applied following a power line disturbance conditions. Specifically, if the energy storage capacitor is not sufficiently discharged during the time the input power is lost, the peak inrush-current may exceed the specified limit when the input power is reapplied. As a result, this prior art approach requires additional circuitry to ensure proper control of inrush current for warm startup conditions.

Another prior art inrush-current limiter circuit is disclosed in U.S. Pat. No. 5,930,130, issued to Katyl. The disclosed circuit in Katyl comprises a resistor connected in parallel with a switch that is in series with the energy storage capacitor. During the period immediately after the input power is applied, the switch is kept open so that the resistor provides inrush current limiting. After the energy storage capacitor is charged, the switch is closed to minimize the power loss. This approach also requires an additional circuit to ensure a proper inrush-current limiting during the warm startup conditions. For example, U.S. Pat. No. 6,714,429, issued to Phadke on Mar. 30, 2004, discloses an inrush-current circuit in a AC-DC power converter by providing a control circuit that limits the inrush current during the cold and warm startup during power line disturbance conditions. Another prior art example is disclosed in U.S. Pat. No. 6,445,165 B1 issued to Malik et al. discloses the use of an AC detector coupled to a low voltage drop semiconductor to minimize inrush current. All of the above referenced prior art therefore require separate circuitry for accommodating various operating conditions of the power supply, thereby making these approaches complex and costly to implement.

Therefore, there exists a need for a simple current control circuit that limits inrush current under any operating condition, including cold startup, warm startup, and power line disturbance conditions.

### SUMMARY OF THE INVENTION

Briefly, according to the present invention, a control circuit limits the inrush current flowing through the energy storage capacitor of a power supply during an inrush current period (i.e., the period immediately after input power is first applied or re-applied under cold startup and warm startup conditions) by supplying a substantially constant current to charge the energy storage capacitor. In one embodiment, the constant current is supplied by maintaining a constant current through a semiconductor device such as a Field Effect Transistor (FET), Metal Oxide Semiconductor Field Effect Transistor (MOSFET), or Insulated Gate Bipolar Transistor (IGBT). Preferably, the semiconductor device is coupled in series with the energy storage capacitor to operate with a constant current, for example, by substantially fixing a gate voltage (or base voltage) of the device. The magnitude of the constant current flowing trough the device can be controlled by the magnitude of the gate or base voltage. Alternatively, inrush current can be limited by providing a substantially constant base current to a Bipolar Junction Transistor (BJT).

More specifically, the present invention relates to a current control circuit for controlling inrush current through an energy storage capacitor of a power supply having an input source. A semiconductor device is coupled in series to the energy storage capacitor, and a control circuit produces a constant current through the semiconductor device during an inrush current period when the energy storage capacitor is charged by the input voltage to bias the semiconductor device to substantially act as a short.

According to one of the more detailed features of the present invention, the semiconductor device comprise at least one of a Field Effect Transistor, a Metal Oxide Semiconductor Field Effect Transistor, or an Insulated Gate Bipolar Transistor, and a Bipolar Junction Transistor.

According to another of the more detailed features of the present invention, the control circuit comprises at least one of a control circuit that generates a constant voltage and a control circuit that generates a constant current.

### BRIEF DESCRIPTION OF THE DRAWINGS

FIG. 1 shows an exemplary embodiment of the present invention that controls the inrush-current by using an IGBT device operated as a constant-current source by connecting the gate terminal to a substantially constant DC voltage.

FIG. 2 shows an exemplary embodiment of the present invention that controls the inrush-current by using a MOSFET device operated as a constant-current source by connecting the gate terminal to a substantially constant DC voltage.

FIG. 3 shows an exemplary embodiment of the present invention that controls the inrush-current by using a BJT device operated as a constant-current source by supplying a substantially constant base current.

### DETAILED DESCRIPTION OF THE INVENTION

A power supply having an input source uses a current control circuit according to the present invention for controlling inrush current through an energy storage capacitor at its output stage. The power supply can be any type of power supply such as an AC-DC or a DC-DC power supply. The current control circuit includes a semiconductor device and a control circuit. The semiconductor device is coupled in series to the energy storage capacitor to charge it with a constant current that is supplied by the input source during the inrush current period. The control circuit biases the semiconductor device to produce the constant current for charging the capacitor during the inrush current period. The energy storage capacitor is charged to bias the semiconductor device to substantially act as a short during the normal operation of the power supply.

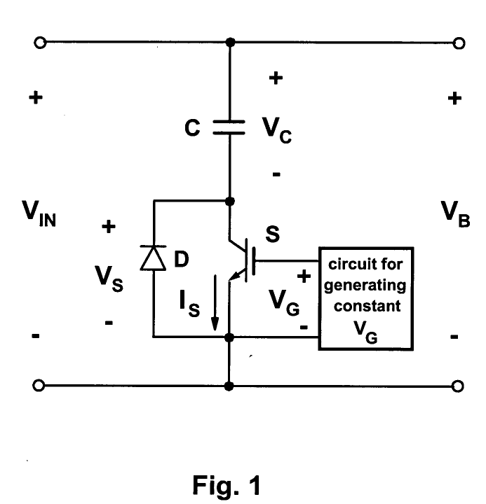

FIG. 1 shows one exemplary embodiment of the current control circuit of the present invention. As shown, the current control circuit comprises the energy storage capacitor C, a semiconductor device comprising an IGBT switch S, an anti-parallel diode D, and a control circuit that generating a substantially constant gate-drive voltage V_{G}. Examples of such circuit includes a Zener diode, a voltage regulator, or a reference voltage generator.

Before positive input voltage V_{IN} is applied at the input terminal, the energy storage capacitor voltage V_{C} is zero and the currents through the IGBT switch S and diode D are also zero. Immediately after input voltage V_{IN} is applied, the voltage across the IGBT switch S becomes equal to input voltage V_{IN} because energy storage capacitor voltage V_{C} cannot increase immediately. Since the gate terminal of IGBT switch S is connected to constant voltage V_{G}, which is higher than the threshold voltage of the IGBT device, the current through the IGBT switch S is constant. As a result, during the inrush current period immediately after input voltage V_{IN} is applied, the energy storage capacitor C is charged with a constant current having a magnitude that can be controlled by a proper selection of constant gate-drive voltage V_{G}. Because the constant switch current I_{S} flows into the energy storage capacitor C, energy storage capacitor voltage V_{C} increases linearly, whereas the switch voltage V_{S} decreases linearly since the sum of energy storage capacitor voltage V_{C} and switch voltage V_{S} is equal to input voltage V_{IN}. When the switch voltage V_{S} becomes equal to input voltage V_{IN}, the switch current I_{S} is maintained substantially constant. Once the switch voltage V_{S} decreases to saturation voltage V_{SAT} of the IGBT device (typically below a couple of volts), the switch is biased to enter the saturation region and act substantially as a short switch. When the switch S is biased to act as a short circuit, the switch current is determined by the energy storage capacitor current, which is solely based on the rest of the circuit and the loading conditions of the power supply. Generally, in the saturation region, the switch exhibits a relatively very low power that does not have detrimental effect on power supply efficiency.

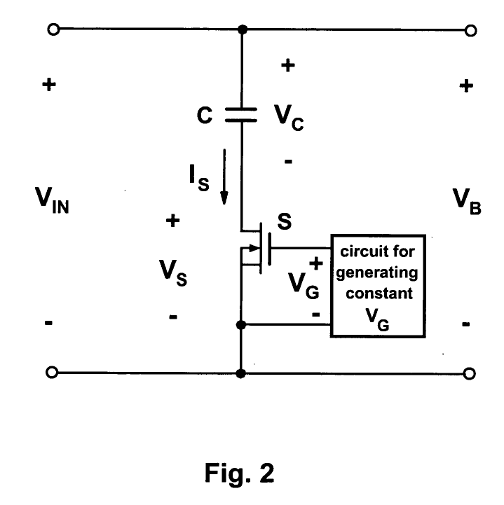

FIG. 2 shows another exemplary embodiment of the invention that comprises energy storage capacitor C, MOSFET device S, and a circuit for generating a substantially constant gate-drive voltage V_{G}. The operation of this exemplary embodiment is very similar to the circuit shown in FIG. 1 except that the external anti-parallel diode is not shown in FIG. 2 because MOSFET devices have these diodes built-in.

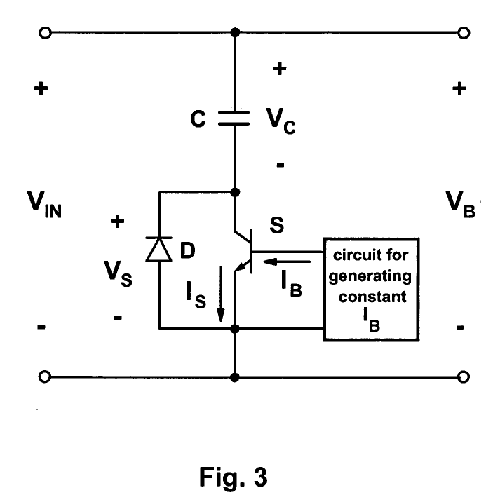

FIG. 3 shows another embodiment of the invention that comprises energy storage capacitor C, BJT device S, anti-parallel diode D, and a circuit for generating a substantially constant base current IB. Examples of such circuit include a current mirror, a series base resistor connected to a voltage source, or a series constant-gate-voltage MOSFET switch connected to a voltage source. Because the maximum current flowing through a BJT device is proportional to its base current, the inrush current can be kept constant by providing a constant base current I_{B} to the BJT switch, as shown in FIG. 3.

From the foregoing it would be appreciated that by charging the energy storage capacitor with constant current during the inrush current period, the present invention provides reliable inrush-current limiting for all operating conditions, i.e., cold startup, warm startup, and power source disturbances, without any additional in current control circuitry.

1. A current control circuit for controlling inrush current through an energy storage capacitor of a power supply having an input voltage, comprising:
a semiconductor device coupled in series to the energy storage capacitor; and
a control circuit that produces a constant current through the semiconductor device during an inrush current period when the energy storage capacitor is charged by the input voltage to bias the semiconductor device to act as a short switch.

2. The circuit of claim 1, wherein the semiconductor device comprise a Field Effect Transistor,

3. The circuit of claim 1, wherein the semiconductor device comprise a Metal Oxide Semiconductor Field Effect Transistor,

4. The circuit of claim 1, wherein the semiconductor device comprise an Insulated Gate Bipolar Transistor

5. The circuit of claim 1, wherein the semiconductor device comprise a Bipolar Junction Transistor.

6. The circuit of claim 1, wherein the control circuit comprises a control circuit that generates a constant voltage

7. The circuit of claim 1, wherein the control circuit comprises a control circuit a control circuit that generates a constant current.

8. A power supply having an input voltage source to provide an output voltage, comprising:
an energy storage capacitor; and
a current control circuit comprising:
a semiconductor device coupled in series to the energy storage capacitor; and
a control circuit that produces a constant current through the semiconductor device during an inrush current period when the energy storage capacitor is charged by the input voltage to reach an energy storage capacitor voltage that causes the semiconductor device to act as a short switch.

9. The power supply of claim 8, wherein the semiconductor device comprise a Field Effect Transistor,

10. The power supply of claim 8, wherein the semiconductor device comprise a Metal Oxide Semiconductor Field Effect Transistor,

11. The power supply of claim 8, wherein the semiconductor device comprise an Insulated Gate Bipolar Transistor

12. The power supply of claim 8, wherein the semiconductor device comprise a Bipolar Junction Transistor.

13. The power supply of claim 8, wherein the control circuit comprises a control circuit that generates a constant voltage

14. The power supply of claim 8, wherein the control circuit comprises a control circuit a control circuit that generates a constant current.
